(19) United States
(12) Patent Application Publication
(10) Pub. No.: US 2018/0137300 A1
(43) Pub. Date: May 17, 2018

(54) METHOD AND APPARATUS FOR DOCUMENT PREVIEW AND DELIVERY WITH PASSWORD PROTECTION

(71) Applicant: BARRACUDA NETWORKS, INC., Campbell, CA (US)

(72) Inventors: Fleming Shi, Scotts Valley, CA (US); Luo Wang, San Jose, CA (US)

(21) Appl. No.: 15/814,250

(22) Filed: Nov. 15, 2017

Related U.S. Application Data
(60) Provisional application No. 62/423,628, filed on Nov. 17, 2016.

(51) Int. Cl. G06F 21/62; H04L 29/06; G06F 17/30

(52) U.S. Cl. CPC G06F 21/6218; H04L 63/083; G06F 17/30011; H04L 63/20; H04L 63/0428; H04L 63/105

(57) ABSTRACT

A new approach is proposed that contemplates systems and methods to support safe preview and immediate delivery of a document from a document producer to an end user while protecting the user from accidentally opening the original document if it has been tampered with by an email attacker. First, the original document is submitted to a safe preview server cluster, where a passcode is generated for the document and the document is processed for policy assessments of possible security threats. The document is then encrypted with the generated passcode and provided to the user together with results of the policy assessments and a preview of content of the document for preview upon request. Based on the user's choice, the user can retrieve the passcode from the server and decrypt the document with the passcode wherein the original document is deleted from the safe preview server cluster once it is downloaded.

### CROSS-REFERENCE TO RELATED APPLICATIONS

This application claims the benefit of U.S. Provisional Patent Application No. 62/423,628, filed Nov. 17, 2016, and entitled “Method and apparatus for document preview and delivery with password protection,” which is incorporated herein in its entirety by reference.

### BACKGROUND

Today, email systems are increasingly facing threats from attackers who intend to hack into the email systems to steal information of its users. One methodology often employed by the attackers involves attaching one or more “weaponized” or tampered documents in Microsoft Office and other popular document formats to an email, wherein the documents often trigger malicious application(s) (malware) having the ability to assert shell commands, scripting languages and other system-level operations on a host computer of a recipient of the attacked email. Given the risks exposed via these applications, it is important to provide some way to look into/inspect content of the documents before actually launching the native applications dedicated for these documents on the host of the user.

Currently, most solutions for downloading a document attached to the email adopt an approach of stubbing the document with a link to a document server, providing to the recipient of the document both a text content preview of the document and the stubbed link to download the original document from the server. The issue with such approach is that it depends on the stubbed link pointing to the server-side storage of the original document, wherein such link is error prone due to storage capacity limitations on the server side. It is desirable to be able to inspect the document attached to the email with less dependency on the storage capacity limitations and/or retention period for the original document on the server-side.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support safe document preview and delivery in accordance with some embodiments.

FIG. 2A depicts a sequence diagram illustrating operations and interactions between the safe preview server cluster, the document portal, and the workload appliances in the system depicted in FIG. 1 in online mode in accordance with some embodiments.

FIG. 2B depicts a sequence diagram illustrating operations and interactions between the safe preview server cluster, the document portal, and the workload appliances in the system depicted in FIG. 1 in offline mode in accordance with some embodiments.

FIG. 3 depicts a flowchart of an example of a process to support safe document preview and delivery in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support safe preview and immediate delivery of a document from a document producer (e.g., workload appliances) to an end user while protecting the user from accidentally opening the original document if it has been tampered with by an email attacker as a weapon against a host computer of the end user. First, the original document is submitted to a safe preview server cluster, where a passcode is generated for the document and the document is processed for policy assessments of possible security threats. The document is then encrypted with the generated passcode and provided to the user together with results of the policy assessments and a preview of content of the document for preview. Based on the user's choice, the user can retrieve the passcode from the server and decrypt the document with the passcode wherein the original document is deleted from the safe preview server cluster once it is downloaded.

By eliminating the need to retain the original document on a document server for a prolonged period of time, the proposed approach reduces service liability on the server side. Additionally, since storing the passcode and/or meta-data of the document on the server side takes a lot less storage than the original document, the proposed approach is very scalable and is unrestricted by the capacity and/or retaining time constraint on the server, thus providing a truly distributed document deployment model.

As referred to herein, the term document (artifact or payload) can be but is not limited to one of or a combination of one or more of text, image, audio, video, or any other type of data in an electronic document format (for non-limiting examples, MS Word, PDF, Google Docs, etc.) that is attachable and deliverable over a network.

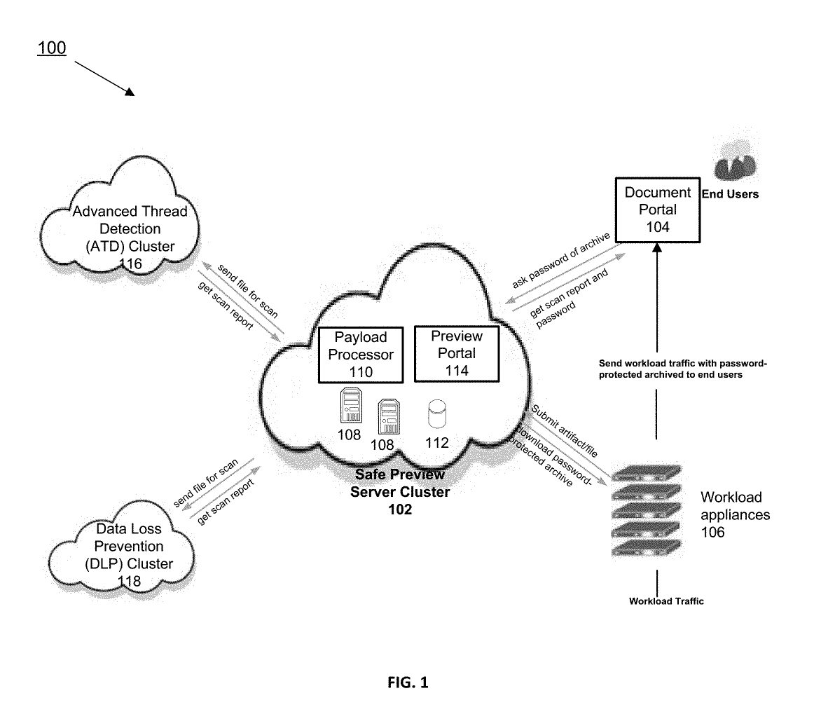

FIG. 1 depicts an example of a system diagram 100 to support safe document preview and delivery. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a safe preview server cluster 102 configured to enable safe preview and delivery of documents from one or more document producers (e.g., workload traffic) to one or more end users and a document portal 104 configured to enable the end users to interact with the safe preview server cluster 102 and preview the documents to be delivered. In some embodiments, the safe preview server cluster 102 comprises a plurality of safe preview servers 108 each configured to accept, inspect, and deliver a document from a document producer. Here, the safe preview cluster 102 can be deployed in a public cloud, a private cloud, or located on premise of an end user. The document portal 104 runs on a host computing device/host (not shown) associated with one of the end users.

As used herein, the term server or host refers to software, firmware, hardware, or other component that is used to effectuate a purpose. Each server or host typically includes a computing unit and software instructions that are stored in a storage unit such as a non-volatile memory (also referred to as secondary memory) of the computing unit for practicing one or more processes. When the software instructions are executed, at least a subset of the software instructions is loaded into memory (also referred to as primary memory) by the computing unit, the computing unit becomes a special purpose for practicing the processes. The processes may also be at least partially embodied in the computing unit into which computer program code is loaded and/or executed, such that, the computing unit becomes a special purpose computing unit for practicing the processes. When implemented on a general-purpose computing unit, the computer program code segments configure the computing unit to create specific logic circuits. Each server or host can be a computing device, a communication device, a storage device, or any electronic device capable of running a software component. For non-limiting examples, a computing device can be but is not limited to a laptop PC, a desktop PC, an iPod, an iPhone, an iPad, a Google's Android device, or a server machine. A storage device can be but is not limited to a hard disk drive, a flash memory drive, or any portable storage device.

In the example of FIG. 1, the document producers are associated with one or more workload appliances/computing devices 106 each configured to submit and receive documents to and from the safe preview server cluster 102 and/or the document portal 104 of the end users over a network. Here, each of the appliances 106 can be a computing device, a communication device, a storage device, or any electronic device capable of running a software component.

In the example of FIG. 1, each of the safe preview server cluster 102, the document portal 104, and the workload appliances 106s are configured to communicate with each other following certain communication protocols, such as TCP/IP protocol, over one or more communication networks (not shown). Here, the communication networks can be but are not limited to, internet, intranet, wide area network (WAN), local area network (LAN), wireless network, Bluetooth, WiFi, and mobile communication network. The physical connections of the network and the communication protocols are well known to those of skill in the art.

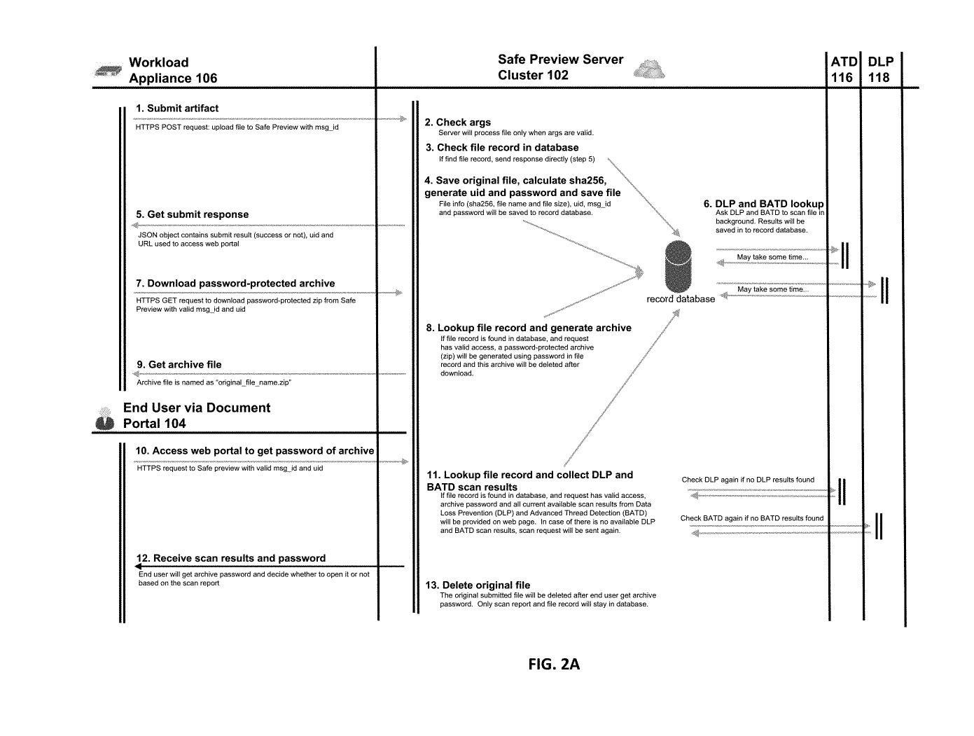

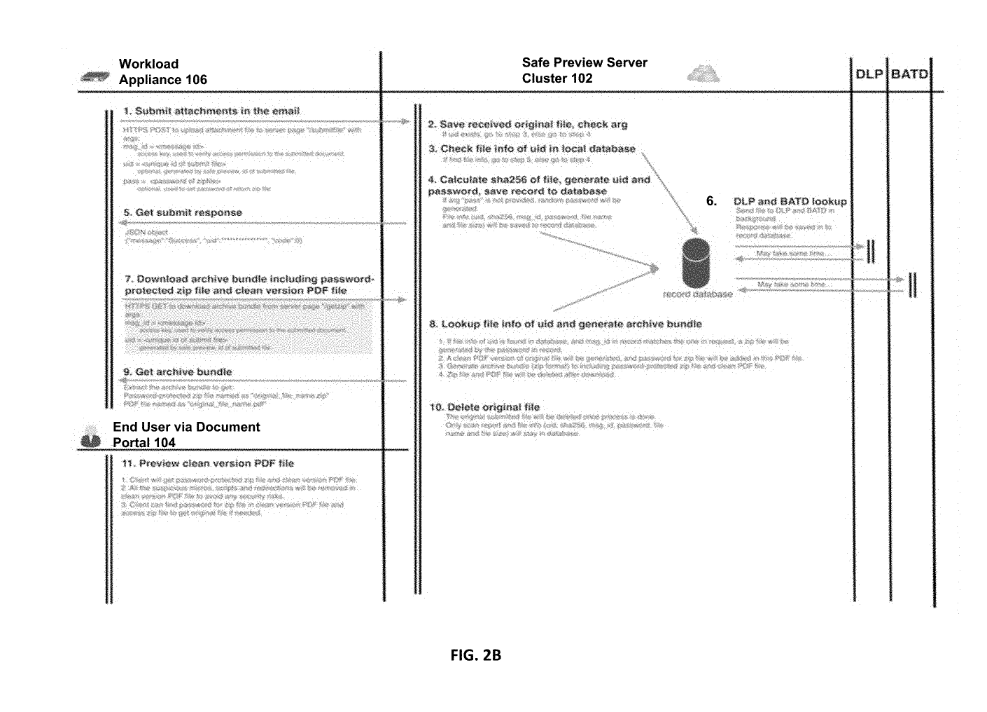

FIG. 2A depicts a sequence diagram illustrating operations and interactions among the safe preview server cluster 102, the document portal 104, and the workload appliances 106s in the system 100 depicted in FIG. 1 in online mode. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

As depicted by the diagram in FIG. 2A, a workload appliance 106 is configured to submit a document to the safe preview server cluster 102 via, for a non-limiting example, a HTTP Post request. In some embodiments, the document is submitted together with a plurality of parameters/arguments, including but not limited to a message ID, a plurality of necessary security authorization/measures that limit access to the submitted document only to a group of permitted consumers/end users, and an appliance identifier/ID (e.g., serial number) of the workload appliance 106 as well as other credentials of the document producer associated with the workload appliance 106 that can be used for authentication purposes. Here, the security authorization/measures include but are not limited to privileges, authorized levels, time periods, and identifiers of the end users permitted to access the document.

During initial ingestion of the submitted document, a payload processor 110 running on one or more servers 108 of the safe preview server cluster 102 is first configured to check validity of the plurality of parameters submitted with the document. If the parameters accompanying the document are determined to be valid, the payload processor 110 proceeds to process the document by first looking it up from file records in a record database 112 of the safe preview server cluster 102. If a file record matching the document is found, i.e., the document has been submitted by the workload appliance 106 before, the payload processor 110 proceeds to provide a submission response to the workload appliance 106, wherein the submission response includes one or more of an indication of whether the document submission is successful or not, a unique ID for the document, and an access URL used to access a preview of the document. In some embodiments, the submission response is in the form of a JSON object, which is an open-standard language-independent data object that uses non-binary human-readable text to transmit data. If the submitted document is new to the safe preview server cluster 102 (not found in the record database 112), the payload processor 110 is configured to save the original document submitted to the record database 112 and calculate a key/passcode in a form of signature, e.g. Secure Hash Algorithm (SHA) or MD 5 of the document used to protect and limit access to the document. The payload processor 110 is also configured to generate the unique ID of the document used to create the access URL for previewing content of the document. The payload processor 110 is then configured to create a new file record associated the document in the record database 112 before providing a submission response to the workload appliance 106. Here, the file record includes one or more of file information (e.g., signature, file name and size of the document), the unique ID, and the passcode, the message ID, and the security measures of the document.

After the submitted document has been accepted, the payload processor 110 of the safe preview server cluster 102 is configured to process the document for various types of policy assessments to obtain information on security risks of the document and to enable the end user to make an intelligent choice on how to handle the document. In some embodiments, the payload processor 110 is configured to provide the document to be scanned in background by a set of policy assessment tools, which include but are not limited to data loss protection (DLP) assessment cluster 116, which scans and identifies leakage or loss of data in the document, and advanced threat detection (ATD) assessment cluster 118, which scans and identifies viruses, malware, and other potential threat by the document. During the policy assessment process, the safe preview server cluster 102 is configured to asynchronously communicate with the backend policy assessment tools via one or more trusted network communication links. Note that the policy assessments can be an asynchronous process since it takes time to complete. Once the policy assessments are complete (after time elapses from the initial submission and ingestion of the document), the results of the policy assessments including but not limited to threat level and security risks of the original document are returned from the policy assessment tools to the payload processor 110, saved in the record database 112 and available for preview by the end user.

If the submission response received from the payload processor 110 indicates that the document has been successfully submitted, the workload appliance 106 is configured to request to download the document from the safe preview server cluster 102 as a passcode-protected document for transmission to the end user. In some embodiments, the request by the workload appliance 106 is in the HTTP GET format and may include parameters including but not limited to the unique ID for the document and a valid message ID. Upon receiving the request from the workload appliance 106, the payload processor 110 is configured to look up a file record of the requested document from the record database 112 using the unique ID of the document. If the file record is found and the parameters submitted with the request are valid, the payload processor 110 is configured to retrieve the requested document from the record database 112 and generate an encrypted/passcode-protected version of the document using the passcode from the file record of the document. The workload appliance 106 may be able to download the passcode-protected document and proceed to further route the passcode-protected document to the end user, for a non-limiting example, as an email attachment. Once the passcode-protected document is downloaded, it is deleted from the safe preview server cluster 102.

Once the end user receives the passcode-encrypted document via the document portal 104 running on a host, the document portal 104 is configured to request the passcode of the document from the safe preview server cluster 102 by, for a non-limiting example, submitting a HTTPS request with the unique ID of the document and a valid message ID. Upon receiving the request, the payload processor 110 is configured to look up the file record of the document by its unique ID, scan and collect all policy assessment results such as DLP and ATD results that are currently available as well as the passcode of the document from the record database 112 if the request is valid and the file record is found in the record database 112. The policy assessment results, the passcode, a preview of text content of the document, and all information needed for the end user to decide whether to move forward on opening the original document are then made available to be accessed by the end user via the URL pointing to a preview web portal/page/site 114 hosted on one or more servers 108 of the safe preview server cluster 102. In some embodiments, access to the preview web portal 114 is governed by the security measures in combination with encrypted, unique and protected recipes of meta-data including but not limited to message ID, and the unique ID of the document. In case the policy assessment results are not yet available, the payload processor 110 is configured to periodically check the policy assessment tools such as the DLP assessment cluster 116 and the ATD assessment cluster 118 for the policy assessment results.

Once the end user has previewed the content as well as the overall policy assessment of the document via the URL of the preview web portal 114, the end user then decides whether to proceed with opening the passcode-protected document or abandon further actions at this point. If the end user does decide to open the document, the end user fetches the passcode provided via the preview web portal 114 and decrypts the passcode-protected document to retrieve the original document.

After the passcode and/or the document has been successfully retrieved by the end user following the sequence of events described above, the safe preview server cluster 102 proceeds to clean up and delete the originally-submitted document and its residual data from the record database 112. In some embodiments, the safe preview server cluster 102 keeps meta-data of the document such as the file record and the policy assessment results of the document available for re-retrieval and further review.

FIG. 2B depicts a sequence diagram illustrating operations and interactions among the safe preview server cluster 102 and the workload appliances 106s in the system 100 depicted in FIG. 1 in offline mode. Compared to the online mode depicted in FIG. 2A and discussed above, in some embodiments, the safe preview server cluster 102 is configured to deliver/present the same information (e.g., a preview of the document) to the client via a safe PDF representation, e.g., via a static PDF document or any text file, making the URL of the preview web portal 114 optional. The passcode to open the protected archive is presented in the PDF document. As such, the preview web portal 114 is not the only way for the client to access the information as the client can prereview the same information offline via the PDF representation even without a network connection and/or access to the online preview web portal 114.

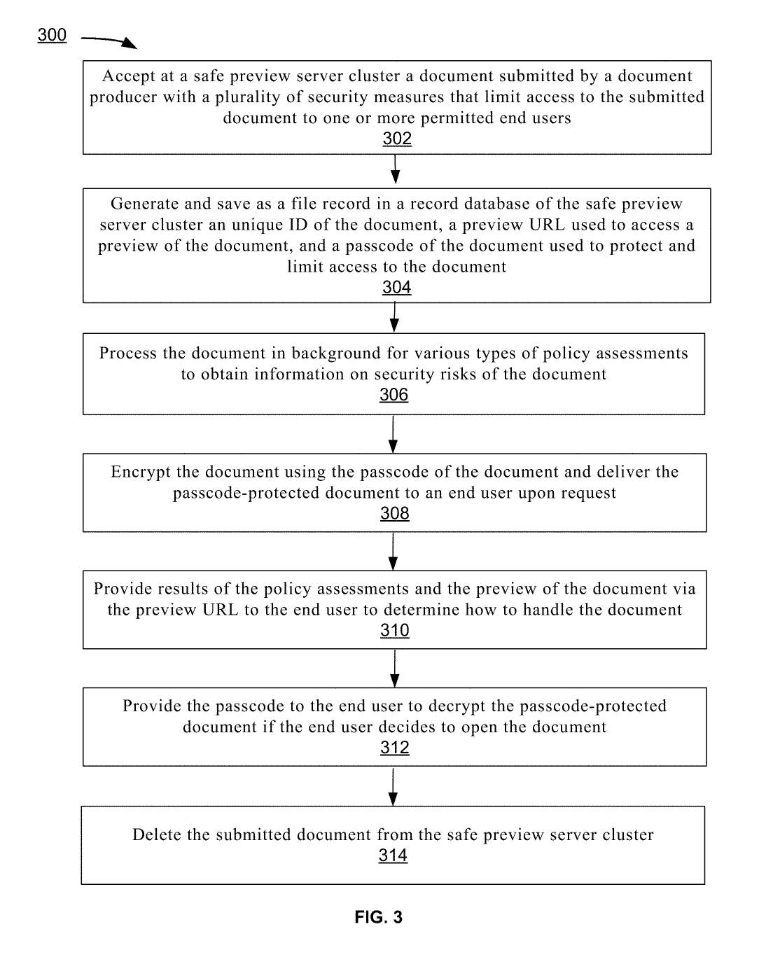

FIG. 3 depicts a flowchart 300 of an example of a process to support safe document preview and delivery. In the example of FIG. 3, the flowchart 300 starts at block 302, where a document submitted by a document producer with a plurality of security measures that limit access to the submitted document to one or more permitted end users is accepted by a safe preview server cluster. The flowchart 300 continues to block 304, where as a unique ID of the document, a preview URL used to access a preview of the document, and a passcode of the document used to protect and limit access to the document are generated and saved as a file record in a record database of the safe preview server cluster. The flowchart 300 continues to block 306, where the document is processed in background for various types of policy assessments to obtain information on security risks of the document. The flowchart 300 continues to block 308, where the document is encrypted using the passcode of the document and the passcode-protected the document is delivered to an end user upon request. The flowchart 300 continues to block 310, where results of the policy assessments and the preview of the document via the preview URL are provided to the end user to determine how to handle the document. The flowchart 300 continues to block 312, where the passcode is provided to the end user to decrypt the passcode-protected document if the end user decides to open the document. The flowchart 300 ends at block 314 where the submitted document is deleted from the safe preview server cluster.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support safe document preview and delivery, comprising:
a safe preview server cluster, which in operation, is configured to
accept a document submitted by a document producer with a plurality of security measures that limit access to the submitted document to one or more permitted end users;
generate and save as a file record in a record database of the safe preview server cluster a unique ID of the document, a preview URL used to access a preview of the document, and a passcode of the document used to protect and limit access to the document;
process the document in background for various types of policy assessments to obtain information on security risks of the document;
encrypt the document using the passcode of the document and deliver the passcode-protected document to an end user upon request;
provide results of the policy assessments and the preview of the document via the preview URL to the end user to determine how to handle the document;
provide the passcode to the end user to decrypt the passcode-protected document if the end user decides to open the document; and
delete the submitted document from the safe preview server cluster.

2. The system of claim 1, wherein:
the safe preview server cluster comprises a plurality of safe preview servers each configured to accept, inspect, and deliver a document from the document producer.

3. The system of claim 1, wherein:
the safe preview cluster is deployed in a public cloud, a private cloud, or located on premise of the end user.

4. The system of claim 1, wherein:
the security measures include one or more privileges, authorized levels, time periods, and identifiers of the end users permitted to access the document.

5. The system of claim 1, wherein:
the safe preview server cluster is configured to check validity of the document and look it up from file records in the record database to determine if the document is valid.

6. The system of claim 1, wherein:
the safe preview server cluster is configured to provide the document to be scanned in background by one or more policy assessment tools including a data loss protection (DLP) assessment cluster configured to scan and identify leakage or loss of data in the document, and an advanced threat detection (ATD) assessment cluster configured to scan and identify viruses, malware, and other potential threat by the document.

7. The system of claim 6, wherein:
the safe preview server cluster is configured to asynchronously communicate with the backend policy assessment tools via one or more trusted network communication links during policy assessment process.

8. The system of claim 7, wherein:
the safe preview server cluster is configured to periodically check the policy assessment tools for the policy assessment results if the policy assessment results are not yet available.

9. The system of claim 1, wherein:
the safe preview server cluster is configured to look up a file record of the requested document from the record database using the unique ID of the document and retrieve the requested document from the record database.

10. The system of claim 1, wherein:
the safe preview server cluster is configured to govern access to the preview URL by the security measures in combination with encrypted, unique and protected meta-data of the document.

11. The system of claim 1, wherein:
the safe preview server cluster is configured to keep meta-data of the document including the file record and the policy assessment results of the document available for re-retrieval and further review.

12. A system to support safe document preview and delivery, comprising:
a safe preview server cluster, which in operation, is configured to
accept a document submitted by a document producer with a plurality of security measures that limit access to the submitted document to one or more permitted end users;
generate and save as a file record in a record database of the safe preview server cluster a unique ID of the document, a rerepresentation of a preview of the document, and a passcode of the document used to protect and limit access to the document;
process the document in background for various types of policy assessments to obtain information on security risks of the document;
encrypt the document using the passcode of the document and deliver the passcode-protected document to an end user upon request;
provide results of the policy assessments and the preview of the document via the static representation to the end user to review and to determine offline how to handle the document;
decrypt the passcode-protected document via the passcode if the end user decides to open the document;
delete the submitted document from the safe preview server cluster.

13. A computer-implemented method to support safe document preview and delivery, comprising:
accepting at a safe preview server cluster a document submitted by a document producer with a plurality of security measures that limit access to the submitted document to one or more permitted end users;
generating and saving as a file record in a record database of the safe preview server cluster a unique ID of the document, a preview URL used to access a preview of the document, and a passcode of the document used to protect and limit access to the document;
processing the document in background for various types of policy assessments to obtain information on security risks of the document;
encrypting the document using the passcode of the document and delivering the passcode-protected document to an end user upon request;
providing results of the policy assessments and the preview of the document via the preview URL to the end user to determine how to handle the document;
providing the passcode to the end user to decrypt the passcode-protected document if the end user decides to open the document;
deleting the submitted document from the safe preview server cluster.

14. The computer-implemented method of claim 13, further comprising:
deploying the safe preview cluster is in a public cloud, a private cloud, or located on premise of the end user.

15. The computer-implemented method of claim 13, further comprising:
checking validity of the document and looking it up from file records in the record database to determine if the document is valid.

16. The computer-implemented method of claim 13, further comprising:
providing the document to be scanned in background by one or more policy assessment tools including a data loss protection (DLP) assessment cluster configured to scan and identify leakage or loss of data in the document, and an advanced threat detection (ATD) assessment cluster configured to scan and identify viruses, malware, and other potential threat by the document.

17. The computer-implemented method of claim 16, further comprising:
asynchronously communicating with the backend policy assessment tools via one or more trusted network communication links during policy assessment process.

18. The computer-implemented method of claim 17, further comprising:
periodically checking the policy assessment tools for the policy assessment results if the policy assessment results are not yet available.

19. The computer-implemented method of claim 13, further comprising:
looking up a file record of the requested document from the record database using the unique ID of the document and retrieving the requested document from the record database.

20. The computer-implemented method of claim 13, further comprising:
governing access to the preview URL by the security measures in combination with encrypted, unique and protected meta-data of the document.

21. The computer-implemented method of claim 13, further comprising:
keeping meta-data of the document including the file record and the policy assessment results of the document available for re-retrieval and further review.

22. A computer-implemented method to support safe document preview and delivery, comprising:
accepting at a safe preview server cluster a document submitted by a document producer with a plurality of security measures that limit access to the submitted document to one or more permitted end users;
generating and saving as a file record in a record database of the safe preview server cluster a unique ID of the document, a static representation of a preview of the document, and a passcode of the document used to protect and limit access to the document;
processing the document in background for various types of policy assessments to obtain information on security risks of the document;
encrypting the document using the passcode of the document and delivering the passcode-protected document to an end user upon request;
providing results of the policy assessments and the preview of the document via the static representation to the end user to review and to determine offline how to handle the document;
decrypting the passcode-protected document via the passcode if the end user decides to open the document;
deleting the submitted document from the safe preview server cluster.
